(19) United States
(12) Patent Application Publication
(10) Pub. No.: US 2024/0373139 A1
(43) Pub. Date: Nov. 7, 2024

(54) IMAGE SENSOR FOR EVENT DETECTION

(71) Applicant: Sony Semiconductor Solutions Corporation, Kanagawa (JP)

(72) Inventor: Diederik Paul MOEYS, Stuttgart (DE)

(73) Assignee: Sony Semiconductor Solutions Corporation, Kanagawa (JP)

(21) Appl. No.: 18/689,876

(22) PCT Filed: Sep. 14, 2022
(86) PCT No.: PCT/EP2022/075579

§ 371 Date: Mar. 7, 2024

(30) Foreign Application Priority Data
Sep. 16, 2021 (EP) 21197182.5

(51) Int. Cl. H04N 25/11; H04N 25/47; H04N 25/78; H04N 25/79

(52) U.S. Cl. CPC H04N 25/11; H04N 25/47; H04N 25/78; H04N 25/79

(57) ABSTRACT

An image sensor includes a pixel array unit and readout circuits. The pixel array unit includes a plurality of pixel circuits. Each pixel circuit includes a photoelectric conversion element and outputs a pixel event signal. Each pixel circuit is associated with one of n pixel groups, with n being an integer number ≥4. Each readout circuit receives the pixel event signals of one of the pixel groups and outputs group event/address data. The group event/address data contains a time stamp and identifies pixel circuits outputting an active pixel event signal.

### FIELD OF THE INVENTION

The present disclosure relates to an image sensor and to a time-of-flight module. In particular, the present disclosure is related to the field of event detection sensors reacting to changes in light intensity, such as dynamic vision sensors (DVS) and event-based vision sensors (EVS).

### BACKGROUND

Computer vision is concerned with how machines and computers can extract a high level of relevant information from digital images or video. Typical computer vision methods aim to extract, from raw image data obtained by an image sensor, exactly the kind of information the machine or computer uses for other tasks.

Many applications of image sensors such as machine control, process monitoring, or surveillance cameras are based on evaluating the motion of objects in the imaged scene. Conventional image sensors with a large number of pixels arranged in an array provide a sequence of still images (frames). The detection of moving objects in the sequence of frames typically involves elaborate and complex image processing methods.

Event detection sensors like DVS and EVS tackle the problem of motion detection by delivering information only about the position of changes in the imaged scene. Unlike image sensors that transfer large amounts of image information in frames, transfer of information about pixels that do not change can be omitted, resulting in a sort of in-pixel data compression. The in-pixel data compression removes data redundancy and facilitates high temporal resolution, low latency, low power consumption, high dynamic range and little motion blur. DVS and EVS are thus well suited especially for solar or battery powered compressive sensing or for mobile machine vision applications where the motion of the system including the image sensor has to be estimated and where processing power is limited due to limited battery capacity. In principle, the architecture of DVS and EVS allows for high dynamic range and good low-light performance, in particular in the field of computer vision. But despite the event-driven output, the communication bandwidth of DVS and EVS may be insufficient for busy scenes or in noise prone situations.

It is desirable to further improve spatial and temporal resolution in dynamic vision sensors and event-based vision sensors.

### SUMMARY OF INVENTION

A pixel circuit of an image sensor implementing event detection typically includes a photoreceptor conversion block (photoreceptor module) and an event detector circuit. The photoreceptor conversion block includes at least one photoelectric conversion element per pixel. The photoelectric conversion elements are typically arranged in rows and columns and each photoelectric conversion element can be identified by hands of a pixel address that typically includes a row address and a column address. Each photoreceptor conversion block outputs a photoreceptor signal, wherein a voltage level of the photoreceptor signal depends on the intensity of electromagnetic radiation detected by the photoelectric conversion element. The event detector circuit processes the photoreceptor signal and generates event data each time a change in intensity of the electromagnetic radiation exceeds a preset threshold.

A readout circuit detects the event data and compiles event information that includes the pixel address and, if applicable, information about the point in time when the event was detected or read out. In particular, the readout circuit may control the readout of the event data from the various pixel circuits, e.g., at regular time intervals or on request.

The present disclosure mitigates shortcomings of conventional image sensors for event detection.

To this purpose, an image sensor includes a pixel array unit and readout circuits. The pixel array unit includes a plurality of pixel circuits. Each pixel circuit includes a photoelectric conversion element and is configured to output a pixel event signal. Each pixel circuit is associated with one of n pixel groups, wherein n is an integer number equal to or greater than four (n≥4). Each readout circuit receives the pixel event signals of one of the pixel groups and outputs group event/address data, wherein the group event/address data contains a time stamp and identifies pixel circuits outputting an active pixel event signal.

Dividing the pixel array unit into pixel groups with independent readout circuits enables a parallel readout form the pixel array unit. The parallel readout combined with time-stamps for each pixel group data facilitates higher data readout rates from the pixel array unit without losing time accuracy. The parallel readout combined with time-stamps for each pixel group also may reduce activity-dependent jitter. In particular, queuing and processing delays resulting from large data generated by noise and signal-generated events can be reduced. In addition, increase of power consumption due to excessive queuing can be reduced. Image sensors with parallel readout may be particularly advantageous in scenarios employing high-speed imaging and tracking.

The described embodiments, together with further advantages, will be best understood by reference to the following detailed description taken in conjunction with the accompanying drawings.

### BRIEF DESCRIPTION OF THE DRAWINGS

FIG. 1 is a simplified block diagram of an image sensor with an image sensor including a pixel array unit with pixel circuits associated with four pixel groups and with four readout circuits according to an embodiment the present disclosure.

FIGS. 2A to 2C are simplified block diagrams of pixel circuits with photoreceptor modules and in-pixel communication circuits according to embodiments.

FIG. 3 is a simplified block diagram of a sensor array of an image sensor with four pixel groups and with four readout circuits according to an embodiment with time stamp generation units for each pixel group.

FIG. 4 is a simplified block diagram of a sensor array of an image sensor with four pixel groups and with four readout circuits according to an embodiment for asynchronous readout.

FIG. 5 is a simplified block diagram illustrating a synchronization unit for four time stamp generation units according to an embodiment.

FIG. 6 is a simplified block diagram of an event/address representation interface according to an embodiment with a memory circuit.

FIG. 7 is a simplified block diagram of an event/address representation interface according to an embodiment with a serial interface circuit.

FIG. 8 is a simplified block diagram of an event/address representation interface according to an embodiment with a multiple bus interface.

FIG. 9 is a simplified block diagram of a sensor array of an image sensor with four pixel groups according to an embodiment with the pixel circuits of each pixel group arranged in blocks.

FIG. 10 is a simplified block diagram of a sensor array of an image sensor with four pixel groups according to an embodiment with the pixel circuits of the pixel groups arranged in unit cells including one pixel circuit of each pixel group.

FIGS. 11A and 11B include a simplified block diagram of a sensor array and a color filter part for the sensor array according to another embodiment.

FIG. 12 is a simplified schematic cross-sectional view of a portion of an image sensor with one wiring plane according an embodiment.

FIG. 13 is a simplified schematic cross-sectional view of a portion of an image sensor with more than one wiring plane according a further embodiment.

FIG. 14A is a simplified block diagram of a sensor array of an image sensor with four pixel groups and with four readout circuits according to another embodiment for asynchronous readout.

FIG. 14B is a simplified block diagram showing details of a readout circuit of an image sensor according to another embodiment for asynchronous readout.

FIG. 15 is a simplified block diagram of a sensor array of an image sensor with four pixel groups and with four readout circuits according to an embodiment for synchronous (scanning) readout.

FIG. 16 is a simplified circuit diagram of a pixel circuit with simultaneous intensity readout and event detection.

FIG. 17 is a simplified circuit diagram of a pixel circuit switchable between intensity readout and event detection.

FIG. 18 is a block diagram depicting an example of a schematic configuration of a time-of-flight module.

FIG. 19 is a diagram showing an example of a laminated structure of an image sensor according to an embodiment of the present disclosure.

FIG. 20 is a block diagram depicting an example of a schematic configuration of a vehicle control system.

FIG. 21 is a diagram of assistance in explaining an example of installation positions of an outside-vehicle information detecting section and an imaging section of the vehicle control system of FIG. 20.

### DETAILED DESCRIPTION

Embodiments for implementing techniques of the present disclosure (also referred to as “embodiments” in the following) will be described below in detail using the drawings. The techniques of the present disclosure are not limited to the embodiments, and various numerical values and the like in the embodiments are illustrative. In the following description, the same elements or elements with the same functions are denoted by the same reference signs, and duplicate descriptions are omitted.

Connected electronic elements may be electrically connected through a direct, permanent low-resistive connection. e.g., through a conductive line. The terms “electrically connected” and “signal-connected” may also include a connection through other electronic elements provided and suitable for permanent and/or temporary signal transmission and/or transmission of energy. For example, electronic elements may also be electrically connected or signal-connected through electronic switches such as transistors or transistor circuits, e.g. MOSFETs, transmission gates, and others.

Though in the following a technology for fast data readout from image sensors is described in the context of certain types of image sensors for event detection, the technology may also be used for other types of image sensors, e.g. such image sensors that combine event detection and intensity read-out.

Though in the following a technology for fast data readout from image sensors is described with reference to figures showing 16 pixel circuits in four pixel groups for simplicity, the technology may be in particular useful for large pixel array units with more than thousands or millions of pixel circuits associated with four or more, for example multiples of four, pixel groups.

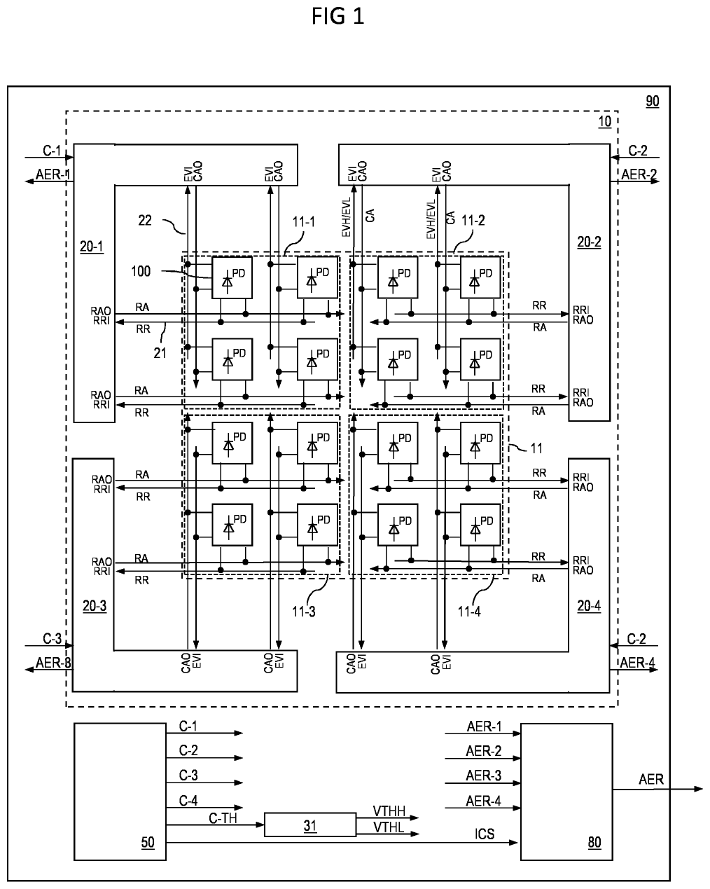

FIG. 1 is a block diagram of an image sensor 90 for event-based image detection.

The image sensor 90 includes a pixel array unit 11 including a plurality of pixel circuits 100 and readout circuits 20-1, . . . , 20-n. Each pixel circuit 100 includes a photoelectric conversion element PD and outputs a pixel event signal. Each pixel circuit 100 is associated with one of n pixel groups 11-1, . . . , 11-n, wherein n is an integer number equal to or greater than four (n≥4). Each readout circuit 20-1, . . . , 20-n receives the pixel event signals of one of the pixel groups 11-1, . . . , 11-n and outputs group event/address data AER-1, . . . , AER-n. Each of the group event/address data AER-1, . . . , AER-n contains a time stamp and identifies pixel circuits 100 outputting an active pixel event signal, e.g. by a pixel address.

In the illustrated embodiment, the integer number n is equal to four (n=4). Alternatively, the integer number n may be any integer, e.g. any even integer number greater than four (n>4). Each pixel group 11-1, . . . , 11-n may include the same or at least approximately the same number of pixel circuits 100. A sensor array 10 includes the pixel array unit 11 and the readout circuits 20-1, . . . , 20-n.

The pixel array unit 11 may be a two-dimensional array, wherein the photoelectric conversion elements PDs may be arranged along straight or meandering rows and along straight or meandering columns. The illustrated embodiment shows a two dimensional array of photoelectric conversion elements PD, wherein the photoelectric conversion elements PD are arranged along straight rows and along straight columns running orthogonal to the rows.

A subset of pixel circuits 100 associated with the photoelectric conversion elements PD of the same row form a pixel row. The pixel circuits 100 of the same pixel row and associated with the same pixel group 11-1, . . . , 11-n may share common row signal lines. A subset of pixel circuits 100 associated with the photoelectric conversion elements PD of the same column form a pixel column. The pixel circuits 100 of the same pixel column and associated with the same pixel group 11-1, . . . , 11-n may share common column signal lines. Each pixel circuit 100 of the pixel array unit 11 can be identified by a pixel address. The pixel address may include a column address describing the position of the pixel circuit 100 along the row direction and a row address identifying the position of the pixel circuit 100 along the column direction.

Each pixel circuit 100 may include a photoreceptor module with at least one photoelectric conversion element PD. Each pixel circuit 100 converts electromagnetic radiation impinging onto a detection area of the photoelectric conversion element PD into digital, e.g. binary event data, wherein the event data indicates an event. Each event indicates a change of the radiation intensity, e.g. an increase by at least an upper threshold amount and/or a decrease by at least a lower threshold amount. Each pixel circuit 100 temporary stores the event data until the event data is passed to the respective readout circuit 20-1, . . . , 20-n through an active pixel event signal. The active pixel event signal may include one or more active signals transmitted through a communication interface with one, two or more signal lines.

For a synchronous readout, the readout circuits 20-1, . . . , 20-n may scan the pixel circuits 100 according to a regular scheme, e.g. row-by-row. The readout circuits 20-1, . . . , 20-n may latch the event data of the pixel circuits 100 and may generate group event/address data AER-1, . . . , AER-n for all pixel circuits 100 whose event data indicate an event.

The illustrated embodiment refers to an event-based readout, wherein each pixel circuit 100 may output one or two active pixel event signals indicating the presence of a stored event in the respective pixel circuit 100. In particular, each pixel circuit 100 may output a row request signal RR and either a low event signal EVL or a high event signal EVH for signaling an event.

Row request lines 21 may connect row request outputs of the pixel circuits 100 associated with the same pixel group 11-1, . . . , 11-n and a row request input RRI of the readout circuit 20-1, . . . , 20-n associated with the respective pixel group 11-1, . . . , 11-n. Each readout circuit 20-1, . . . , 20-n may include as many row request inputs RRI as the respective pixel group 11-1, . . . , 11-n has pixel rows. Each row request line 21 passes the row request signals RR of the pixel circuits 100 of one pixel row within the same pixel group 11-1, . . . , 11-n to the row request input RRI of the readout circuit 20-1, . . . , 20-n associated with the respective pixel group 11-1, . . . , 11-n.

Event signaling lines 22 may connect the low event outputs and the high event outputs of the pixel circuits 100 associated with the same pixel group 11-1, . . . , 11-n with event inputs EVI of the readout circuit 20-1, . . . , 20-n associated with the respective pixel group 11-1, . . . , 11-n. Each readout circuit 20-1, . . . , 20-n may include as many event inputs EVI for low event signals and high event signals as the respective pixel group 11-1, . . . , 11-n has pixel columns. Each event signaling line 22 passes the high event signals EVH and/or low event signals EVL of the pixel circuits 100 of one pixel column within the same pixel group 11-1, . . . , 11-n to an event input EVI of the readout circuit 20-1, . . . , 20-n associated with the respective pixel group 11-1, . . . , 11-n.

Each readout circuit 20-1, . . . , 20-n may generate a column acknowledge signal CA associated with the pixel group column with active high event signal EVH or active low event signal EVL and may output the column acknowledge signal CA at a column acknowledge output CAO. In response to the column acknowledge signal CA, all active pixel circuits 100 of the selected pixel group column may reset the active pixel event signals including the high event signals EVH and the low event signals EVL. Other embodiments may omit the column acknowledge signals CA.

Row address and column address may refer to the respective pixel group 11-1, . . . , 11-n and may identify single rows and columns of the respective pixel group 11-1, . . . , 11-n. Alternatively, row address and column address may refer to the complete pixel array unit 11 and may identify single rows and columns within the complete pixel array unit 11.

Each readout circuit 20-1, . . . , 20-n may output the group event/address data AER-1, . . . , AER-n as serial data stream, as parallel data or as a data packet, wherein each data packet includes a sequence of data bit groups and each data bit group includes a predefined number of bits transmitted in parallel. For example, the data bit groups may be data bytes with the predefined number equal 8 or multiple of data bytes with the predefined number equal to n*8, wherein n is an integer number. Alternatively, the predefined number may be an integer divisor of the total number of the bits of the group event/address data AER-1, . . . , AER-n, by way of example.

In case of a serial event/address interface for outputting a serial data stream or a sequence of data packets, the row address may be transmitted in advance of the column address and a polarity information, wherein the polarity information indicates whether the light intensity has increased or decreased. In particular, one row address may be valid for a plurality of following column addresses and polarity information. Alternatively, e.g. in case of an at least partially parallel event/address interface, the row address may be latched in advance of the following column addresses and may be valid for a sequence of following column addresses.

For event-based readout, data readout from an individual pixel circuit 100 may include, in particular may include not more than individually acknowledging the row request signal RR and the respective low event signal EVL or high event signal EVH of the individual pixel circuit 100, generating the group event/address data AER-1, . . . , AER-n identifying the individual pixel circuit 100, complementing the group event/address data AER-1, . . . , AER-n with time information and passing the time-stamped group event/address data AER-1, . . . , AER-n to a further instance inside or outside the image sensor 90. The group event/address data AER-1, . . . , AER-n may include a time stamp, a row address, a column address, and polarity information about increasing or decreasing light intensity.

A controller 50 may perform part of a sequential control of the processes in the image sensor 90. For example, the controller 50 may generate readout control signals C-1, . . . , C-n to control the readout circuits 20-1, . . . , 20-n.

Alternatively or in addition, the controller 50 may control a threshold voltage generation circuit 30 that determines and supplies one or more reference voltages to individual pixel circuits 100 in the pixel array unit 11, wherein the pixel circuits 100 may use the reference voltage or voltage signals derived from the reference voltage as threshold voltages for comparison decisions. For example, the threshold voltage generation unit 30 illustrated in FIG. 1 may generate the lower and upper threshold voltages VTHL, VTHH and may pass the lower and upper threshold voltages VTHL, VTHH through threshold voltage lines to all pixel circuits 100 of the pixel array unit 11.

Alternatively or in addition, the controller 50 may generate an interface control signal ICS for controlling an event/address representation (AER) interface circuit 80 that receives the pixel group event/address data AER-1. AER-2, AER-3, AER-4 of each pixel group 11-1, . . . , 11-n and that may pass group event/address data AER-1, AER-2, AER-3, AER-4 or global event/address data AER to a signal processing unit outside the image sensor 90.

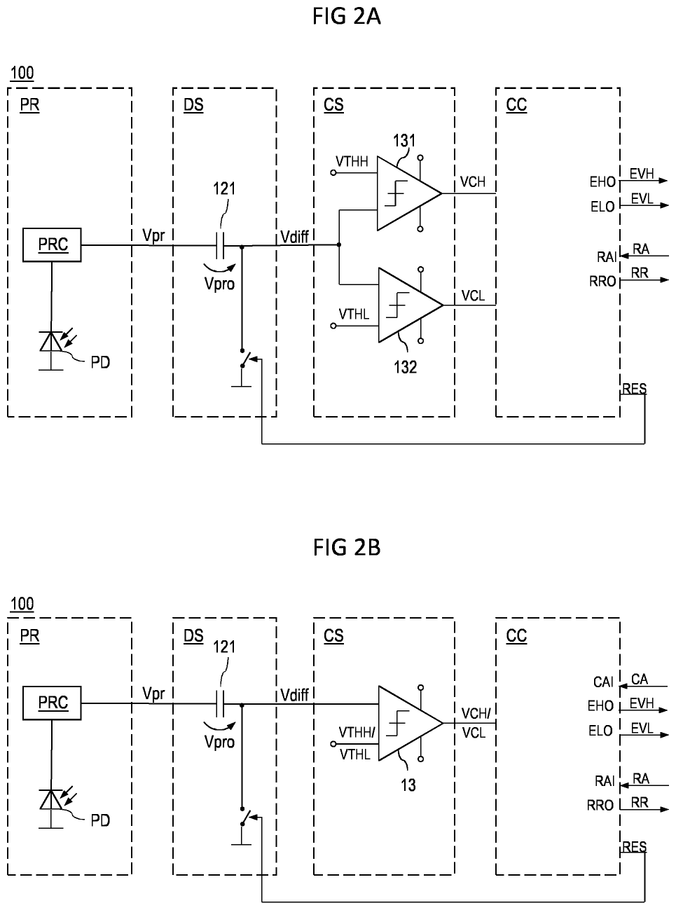

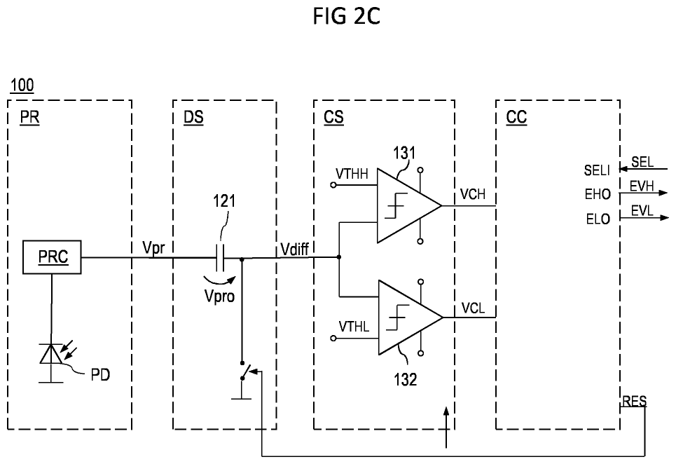

FIGS. 2A to 2B show embodiments of pixel circuits 100 for the pixel array unit 11 illustrated in FIG. 1.

Each pixel circuit 100 includes a photoreceptor module PR, a differencing stage DS, a comparator stage CS, and an in-pixel communication circuit CC.

The photoreceptor module PR includes a photoelectric conversion element PD and outputs a photoreceptor signal Vpr with a voltage level that depends on a detector current generated by the photoelectric conversion element PD.

The photoelectric conversion element PD may include or consist of a photodiode which by means of the photoelectric effect converts electromagnetic radiation incident on a detection surface into the detector current. The electromagnetic radiation may include visible light, infrared radiation and/or ultraviolet radiation. The amplitude of the detector current corresponds to the intensity of the incident electromagnetic radiation, wherein in the intensity range of interest the detector current increases approximately linearly with increasing intensity of the detected electromagnetic radiation.

The photoreceptor module PR may further include a photoreceptor circuit PRC that converts the detector current into a photoreceptor signal Vpr. The voltage of the photoreceptor signal Vpr is a function of the detector current, wherein in the voltage range of interest the voltage amplitude of the current photoreceptor signal Vpr increases with increasing detector current. For example, the voltage of the photoreceptor signal Vpr increases with the detector current logarithmically.

The differencing stage DS subtracts a previously evaluated photoreceptor voltage Vpro from the current photoreceptor signal Vpr to obtain a difference signal Vdiff representing a voltage difference between the previously evaluated photoreceptor voltage Vpro and the present voltage of the photoreceptor signal Vpr. For example, the differencing stage DS may include a memory capacitor 121 that is controlled to store a charge for a voltage drop across the memory capacitor 121 equal to the previously evaluated photoreceptor voltage Vpro.

The comparator stage CS continuously compares the difference signal Vdiff with a lower threshold voltage VTHL and an upper threshold voltage VTHH.

In FIG. 2A the comparator stage CS includes two comparators 131, 132 for simultaneously comparing the difference signal Vdiff with the upper voltage threshold VTHH and with the lower voltage threshold VTHL.

Each comparator 131, 132 may output a digital comparator output signal VCL, VCH, e.g. a binary signal, wherein one of the voltage levels of the comparator output signals indicates that the difference signal Vdiff exceeds the corresponding threshold voltage and wherein another or the other voltage level of the comparator output signal indicates that the difference signal Vdiff does not exceed the corresponding threshold voltage. The comparator output signals represent the event data.

In FIG. 2B the comparator stage CS includes one single comparator 13 for successively comparing the difference signal Vdiff with the upper voltage threshold VTHH and with the lower voltage threshold VTHL. The comparator output signal VCHL contains the results of both comparisons sequentially.

The comparator output signals VCL, VCH, VCHL represent the event data, which may include a high event bit for the result of the comparison of the difference signal Vdiff with the upper voltage threshold VTHH and a low event bit for the result of the comparison of the difference signal Vdiff with the lower voltage threshold VTHL.

The in-pixel communication circuit CC may temporarily store the event data.

The in-pixel communication circuits CC in FIG. 2A and FIG. 2B are suitable for event-triggered readout. The in-pixel communication circuits CC may generate a row request signal RR in case an event has been detected and may output the row request signal RR at a row request output RRO. The row request output RRO may be an open collector output or any other output type allowing a plurality of pixel circuits 100 to be connected to the same row request line. The in-pixel communication circuit CC may further generate a low event signal EVL or a high event signal EVH in case an event has been detected.

In the illustrated embodiment, the in-pixel communication circuit CC includes a low event output ELO and a high event output EHO.

In case the difference signal Vdiff exceeds the upper voltage threshold VTHH, the in-pixel communication circuit CC may generate a high event signal EVH and outputs the high event signal EVH at the high event output EHO. In case the difference signal Vdiff falls below the lower voltage threshold VTHL, the in-pixel communication circuit CC may generate a low event signal EVL and outputs the low event signal EVL at the low event output ELO.

The in-pixel communication circuit CC may set the low or high event signal EVL. EVH active simultaneously with the row request signal RR, wherein the high event outputs EHO and the low event outputs ELO may be open collector outputs or may have any other output type allowing a plurality of pixel circuits 100 to be connected to the same event signaling line.

Alternatively, the in-pixel communication circuit CC may set the low or high event signal active only after being selected by the readout circuit 20-1, . . . , 20-n, wherein the event outputs EHO and low event outputs ELO may be push/pull outputs, by way of example.

The in-pixel communication circuit CC may further include a row acknowledgement input RAI for receiving a row acknowledge signal RA.

In the pixel circuit 100 of FIG. 2B, the in-pixel communication circuit CC may also include a column acknowledgement input CI for receiving a column acknowledge signal CA. According to other examples of the in-pixel communication circuit CC as illustrated in FIG. 2A, the column acknowledgement input CI is omitted and no column acknowledgement signals are passed to the pixel circuits 100.

The in-pixel communication circuit CC may reset an active row request signal RR in response to receiving an active row acknowledge signal RA. In addition, the in-pixel communication circuit CC may trigger an update of the previously evaluated photoreceptor voltage Vpro with the current photoreceptor voltage Vpr in the differencing section DS in response to receiving the row acknowledge signal RA.

The in-pixel communication circuit CC of FIG. 2B may reset the low and high event signals EVL. EVH in response to receiving a column acknowledge signal CA. In the absence of column acknowledgement signals CA and column acknowledgement inputs CI as it is the case in the pixel circuit 100 of FIG. 2A, the in-pixel communication circuit CC may reset the low and high event signals EVL. EVH in response to receiving the active row acknowledge signal RA.

If the in-pixel communication circuit CC includes a storage element holding the event data, the event data may be reset (cleared), in response to receiving the row acknowledge signal RA or in response to receiving the column acknowledge signal CA.

FIG. 2C refers to a pixel circuit 100 for read out at regular time intervals. The pixel circuits 100 are sequentially read out row-by-row. Each readout may trigger an update of the previously evaluated photoreceptor voltage Vpro with the current photoreceptor voltage Vpr in the differencing stage DS. In addition, each readout resets (clears) the event data.

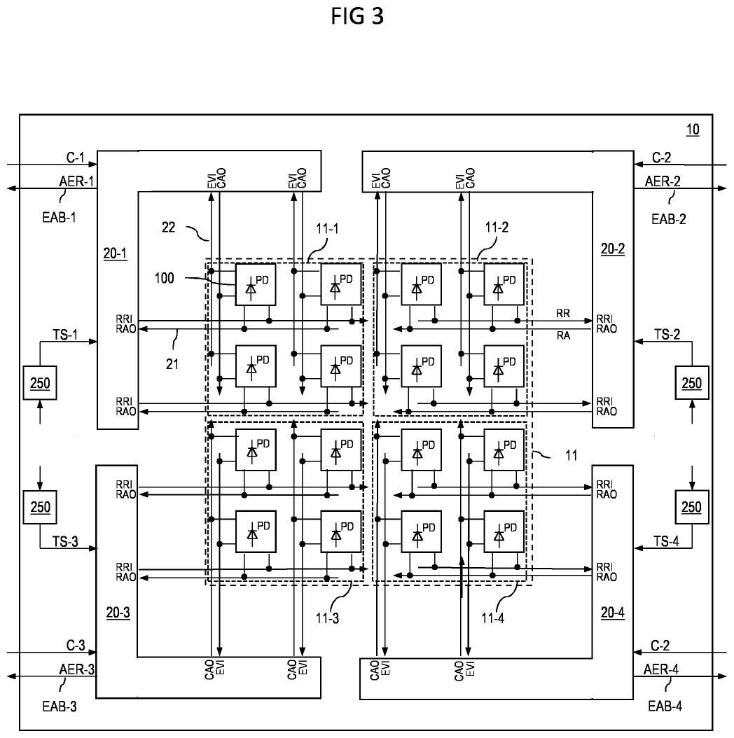

In FIG. 3 the sensor array 10 includes time stamp generation units 250. Each time stamp generation unit 250 generates a time stamp TS-1, . . . , TS-n and passes the time stamp TS-1, . . . , TS-n to one of the readout circuits (20-1, . . . , 20-n). The independent time stamp generation units 250 enable different time stamps TS-1, . . . , TS-n for the group event/address data AER-1, . . . , AER-n of the different pixel groups 11-1, . . . , 11-n.

The time stamp generation units 250 may include a resettable and/or programmable digital counter. The digital counter may include a sequential digital logic circuit with a clock input and one data output for serial output or multiple data outputs for parallel output of the time stamp. The data output represents a number in the binary number system. Each pulse applied to the clock input increments the number.

In particular each readout circuit 20-1, . . . , 20-n is configured to generate and output group event/address data AER-1, . . . , AER-n containing at least a time stamp TS-1, . . . , TS-n and a row address. For example, each readout circuit 20-1, . . . , 20-n outputs the group event/address data AER-1, AER-n as serial data stream or as data packets containing a time stamp TS directly prior to or directly following a row address on a serial group event/address bus EAB-1, . . . , EAB-n. Alternatively, each readout circuit 20-1, . . . , 20-n outputs the group event/address data AER-1, . . . , AER-n in a parallel data format providing at least the time stamp TS and a row address synchronously on a parallel group event/address bus EAB-1, . . . , EAB-n.

Alternatively, the readout circuits 20-1, . . . , 20-n may generate and output group event/address data AER-1, . . . , AER-n that exclusively contains complete combinations of a time stamp TS-1, . . . , TS-n, a row address, a column address, and polarity information about increasing or decreasing light intensity. The readout circuits 20-1, . . . , 20-n may output the group event/address data AER-1, . . . , AER-n through a serial or through a parallel group event/address bus EAB-1, . . . , EAB-n that may include several data lines for the parallel transmission of at least parts of the group event/address data AER-1, . . . , AER-n.

For example, the readout circuit 20-1, . . . , 20-n may trigger the time stamp generation unit 250 to output the current state of the internal counter as time stamp TS-1, . . . , TS-n in response to outputting the row address. Alternatively, the readout circuit 20-1, . . . , 20-n may latch the momentary count of the digital counter in response to receiving the row request signal RR, e.g. in response to receiving the first row request being read out. In case of a scanning readout, the end of each scan may trigger the time stamp generation unit 250 to output the current state of the internal counter as time stamp TS-1, . . . , TS-n.

The time stamps TS-1, . . . , TS-n may be used in combination with synchronous readout and in particular in combination with asynchronous readout. The following Figures focus on an asynchronous, event-based readout using a burst mode word serial event/address representation (AER) for transmitting the event data to a receiver circuit outside the sensor array 10 and inside or outside the image sensor 90.

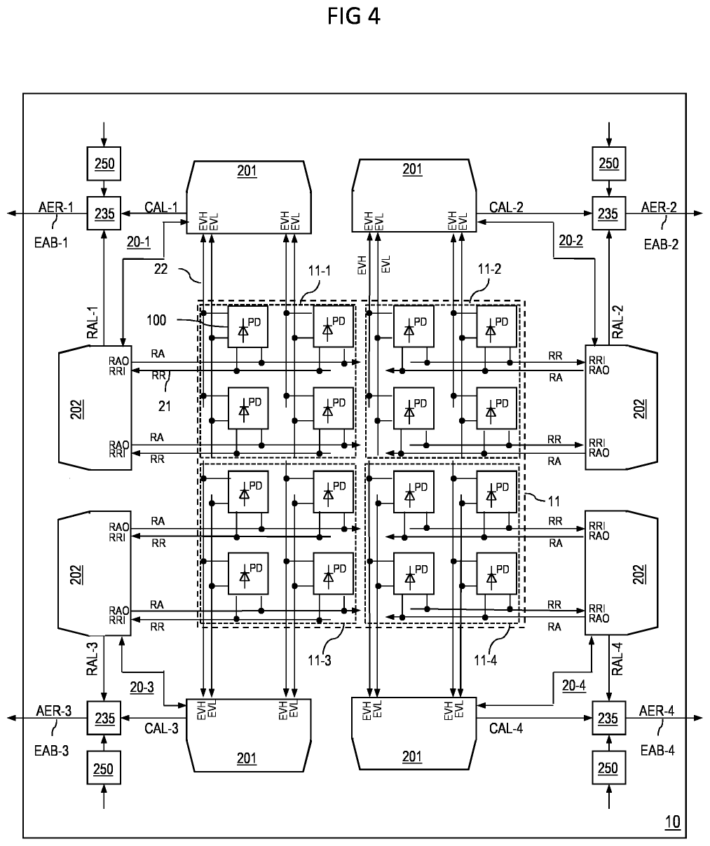

For the sensor array 10 illustrated in FIG. 4, the pixel event signals may include a row request signal RR and each readout circuit 20-1, . . . , 20-n may include a row control circuit 202 that receives the row request signals RR of one pixel group 11-1, . . . , 11-n at a row request input RRI. Each readout circuit 20-1, . . . , 20-n may pass a row address of a pixel group row with active row request signal to a row address bus RAL-1, . . . , RAL-n.

Each row address bus RAL-1, . . . , RAL-n may be a serial data bus with one or two data lines. Alternatively, each row address bus RAL-1, . . . , RAL-n is a parallel data bus with sufficient data lines for parallel data transmission of at least a part of the row address, of complete data bytes, or of complete data words, by way of example.

In addition, in response to each row request signal RR, each readout circuit 20-1, . . . , 20-n may generate a row acknowledge signal RA to the pixel circuits 100 of the pixel group rows with active row request signals RR and may output the row acknowledge signal RA at a row acknowledge output RAO. In response to the row acknowledge signal RA, all active pixel circuits 100 of the selected pixel group row may deactivate the row request signal RR.

In particular, by activating the corresponding row acknowledge signal RA for the requesting pixel group row, the row control circuit 202 selects one pixel row of the pixel group at a time and passes the corresponding row address to the corresponding row address bus RAL-1, . . . , RAL-n. In case more than one row request signals RR are active at the same time in the same pixel group 11-1, . . . , 11-n, the row control circuit 202 selects one of the requesting pixel group rows according to a predefined scheme and for a time necessary to obtain all event data from the selected pixel group row. After all event data from the selected pixel group row is transmitted, the row control circuit 202 selects the next pixel group row with active row request signal RR according to a predefined scheme.

Also according to FIG. 4, the pixel event signals may include a high event signal EVH and a low event signal EVL and each readout circuit 20-1, . . . , 20-n includes a column control circuit 201 that receives the high event signals EVH and the low event signals EVL of one pixel group 11-1, . . . , 11-n and that passes column addresses of pixel group columns with active high event signal EVH or active low event signal EVL to a column address bus CAL-1, . . . , CAL-n.

Each column address bus CAL-1, . . . , CAL-n may be a serial data bus with one or two data lines. Alternatively, each column address bus CAL-1, . . . , CAL-n is a parallel data bus with sufficient data lines for parallel data transmission of at least a part of the column address and the polarity information, of complete data bytes, or of complete data words, by way of example.

An active high event signal indicates an increase of light intensity and an active low event signal indicates a decrease of light intensity—

In particular, the column control circuit 201 selects one pixel group column at a time and passes the corresponding column address to the corresponding column address bus CAL-1, . . . , CAL-n. In case more than one high event signal EVH and low event signal EVL are active at the same time in the same pixel group 11-1, . . . , 11-n, the column control circuit 201 selects one of the corresponding pixel group columns according to a predefined scheme and for a time necessary to write the column address of the pixel group column and the polarity information on the column address bus CAL-1, . . . , CAL-n. After the column address and the polarity information from the selected pixel group column has been passed to the column address bus CAL-1, . . . , CAL-n, the column control circuit 201 selects the next pixel group column according to a predefined scheme. After all column addresses and polarity information from active pixel group columns has been passed to the column address bus CAL-1, . . . , CAL-n, the row control circuit 202 may select the next pixel group row with active row request signal RR according to a predefined scheme.

For each of the readout circuits 20-1, . . . , 20-n, the row address bus RAL-1, . . . , RAL-n passes the row addresses to a combiner unit 235 and for each row address the column address bus CAL-1, . . . , CAL-n passes one or more column addresses and the polarity information to the combiner unit 235. In addition, the respective time stamp generation unit 250 passes the time stamp to the combiner unit 235. The combiner unit 235 may combine one row address, one time stamp, one or more column addresses and corresponding polarity information to group event/address data AER-1, . . . , AER-n in a serial burst mode word format.

The combiner unit 235 may include a multiplexer with three input ports and one output port. The combiner unit 235 may include latches for temporarily storing the data applied to the input ports. The combiner unit 235 may be configured to pass the data applied/stored at the input ports to the event/address bus EAB-1, . . . , EAB-n in form of data packets.

As illustrated in FIG. 5, the sensor array 10 may include a synchronization unit 31 configured to generate a synchronization signal SYNC and to pass the synchronization signal SYNC to each of the time stamp generation units 250. In particular, the time stamp generation units 250 may receive the synchronization signal SYNC simultaneously.

For example, in case the time stamp generation units 250 include digital counters, the synchronization signal SYNC may be passed to the reset inputs of the digital counters.

The sensor array 10 may further include an oscillator circuit 35 generating a clock signal CK, wherein the oscillator circuit 35 passes the clock signal CK to the clock inputs of the digital counters. In particular, the time stamp generation units 250 may receive the clock signal CK synchronously.

The readout circuit 20-1, . . . , 20-n may trigger the time stamp generation unit 250 to output the current state of the internal counter as time stamp TS-1, . . . , TS-n, e.g. in response to outputting the row address on the row address bus RAL-1, . . . , RAL-n.

Alternatively, for each pixel group 11-1, . . . , 11-n the time stamp generation unit 250 may continuously output the count through a serial interface or through a parallel interface and the readout circuit 20-1, . . . , 20-n, e.g. the respective combiner unit 235 may latch the momentary count of the digital counter in response to receiving the row request signal RR or in response to passing the row address on row address bus RAL 11-1, . . . , 11-n.

In particular each readout circuit 20-1, . . . , 20-n may be configured to generate and output group event/address data AER-1, . . . , AER-n containing combinations of a time stamp TS-1, . . . , TS-n and a row address.

For example, in case of serial event/address busses EAB-1, . . . , EAB-n each readout circuit 20-1, . . . , 20-n may output group event/address data AER-1, . . . , AER-n containing a time stamp TS-1, . . . , TS-n directly prior to or directly following a row address. In case of parallel event/address busses EAB-1, . . . , EAB-n, each readout circuit 20-1, . . . , 20-n may output group event/address data AER-1, . . . , AER-n containing a time stamp TS-1, . . . , TS-n and a row address in the same data word or in directly successive data words.

Alternatively, the readout circuits 20-1, . . . , 20-n may generate and output group event/address data AER-1, . . . , AER-n in data bursts, containing exclusively complete combinations of a time stamp, a row address, a column address, and polarity information in directly successive data bit groups, e.g. data words.

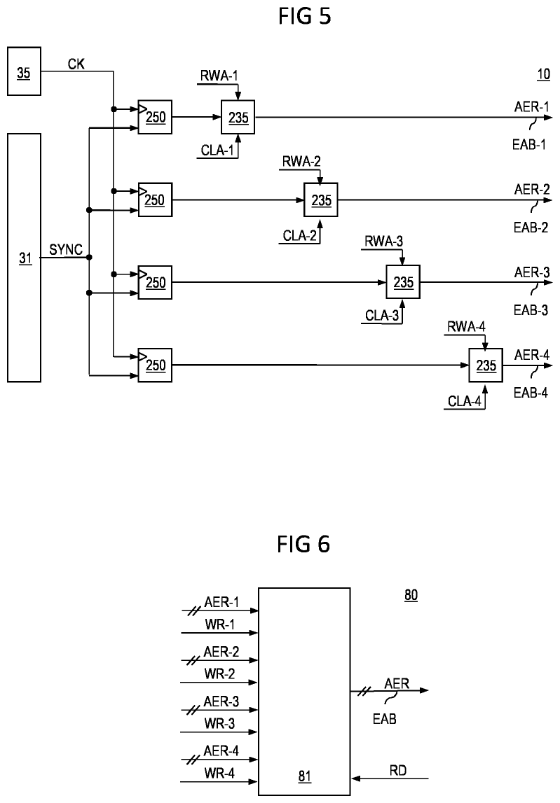

According to FIG. 6 the AER interface circuit 80 of FIG. 1 may include a memory circuit 81 that receives the group event/address data AER-1, . . . , AER-n from the readout circuits 20-1, . . . , 20-n and that stores the group event/address data AER-1, . . . , AER-n.

Each readout circuit 20-1, . . . , 20-n may further pass a write signal WR1, . . . , WRn for controlling the memory circuit 81 to store the group event/address data AER-1, . . . , AER-n. The timing of the write control signals WR1, . . . , WRn from the different readout circuit 20-1, . . . , 20-n may be independent from each other.

The readout from the memory circuit 81 may be group-oriented, wherein the stored group event/address data AER-1, . . . , AER-n for each pixel group 11-1, . . . , 11-n may be selectively read out. The illustrated embodiment provides a global readout with only one read control signal controlling the readout of all group event/address data AER-1. AER-n on the same global event address bus EAB.

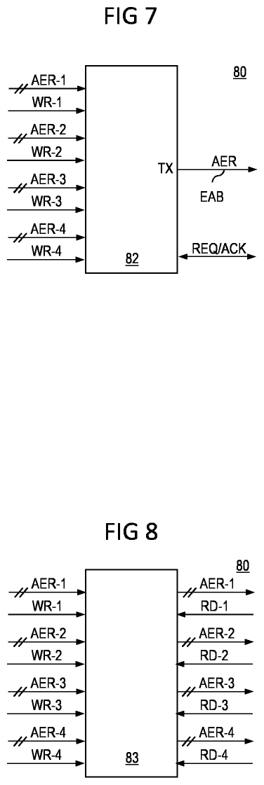

According to FIG. 7 the AER interface circuit 80 of FIG. 1 may include a serial interface circuit 82. The serial interface circuit 82 receives the group event/address data AER-1, . . . , AER-n from the readout circuits 20-1, . . . , 20-n and generates serial event/address data.

The serial interface circuit 82 outputs the serial event/address data AER on a transmit output TX that passes the serial event/address data AER to a global event address bus EAB for serial data transmission. The serial interface circuit 82 may include further control inputs and control outputs supporting a data transmission protocol for serial data transmission, e.g. terminals for data request and/or data acknowledge.

According to FIG. 8 the interface circuit 80 of FIG. 1 may include a multiple bus interface 83 passing the group event/address data AER-1, . . . , AER-n to a complementary bus interface outside the image sensor. The multiple bus interface 83 facilitates parallel data transmission from the sensor array to a higher processing instance and parallel processing of the group event/address data AER-1, . . . , AER-n in the higher processing instance.

The multiple bus interface 83 may be exclusively passive, wherein the multiple bus interface 83 includes wiring lines, contacts and/or other types of electrical interfaces for signal transmission, e.g. through contact vias, bond pads, contact surfaces. In addition, the multiple bus interface 83 may include active components, e.g. transistors or complete driver circuits.

The image sensor 90 may include one, two or all of the memory circuit 81, the serial interface circuit 82, and the multiple bus interface 83.

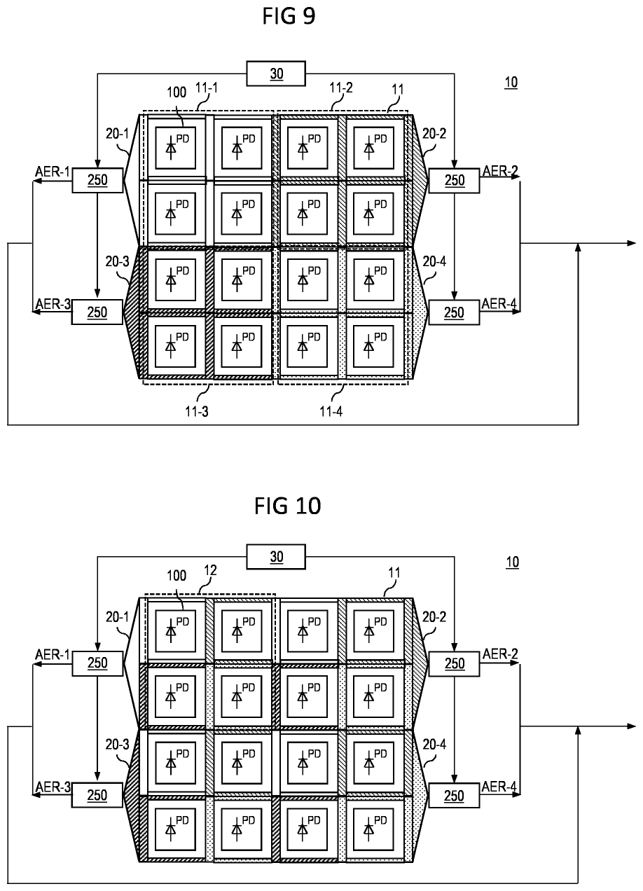

In FIG. 9 and FIG. 10, the wiring lines of pixel circuits 100 associated with different pixel groups 11-1, . . . , 11-n and the corresponding readout circuits 20-1, . . . , 20-n are distinguished by different hatching patterns. A blank hatching pattern marks the wiring lines and the readout circuit 20-1 of the first pixel group 11-1. Falling thin diagonal lines mark the wiring lines and the readout circuit 20-2 of the second pixel group 11-2. Rising thick diagonal lines mark the wiring lines and the readout circuit 20-3 of the third pixel group 11-3. The hatching pattern for the wiring lines and the readout circuit 20-4 of the fourth pixel group 11-4 includes dots.

In FIG. 9 the pixel circuits 100 of each pixel group 11-1, . . . , 11-n are arranged side-by-side in a rectangular part of the pixel array unit 11.

In particular, the pixel circuits 100 of the pixel array unit 11 are arranged matrix-like in rows and columns and the pixel circuits 100 of each pixel group 11-1, . . . , 11-n are arranged with no pixel circuit 100 of another pixel group 11-1, . . . , 11-n formed between them. No pixel circuit 100 of a pixel group 11-1, . . . , 11-n adjoins more than one pixel circuit 100 of the same neighboring pixel group 11-1.

The wiring lines for the pixel array unit 11 of the image sensor according to this embodiment may be easily obtained from existing layouts, e.g. by cutting the wiring lines at the borders between two neighboring pixel groups 11-1, . . . , 11-n.

In FIG. 10 the pixel circuits 100 of the pixel groups 11-1, . . . , 11-n are interleaved with each other.

In particular, the pixel circuits 100 may be arranged in a regular pattern of unit cells 12, wherein each unit cell 12 includes one pixel circuit 100 of each pixel group 11-1, . . . , 11-n. In each unit cell 12, the pixel circuits 100 associated with the different pixel groups 11-1, . . . , 11-n are arranged in the same way.

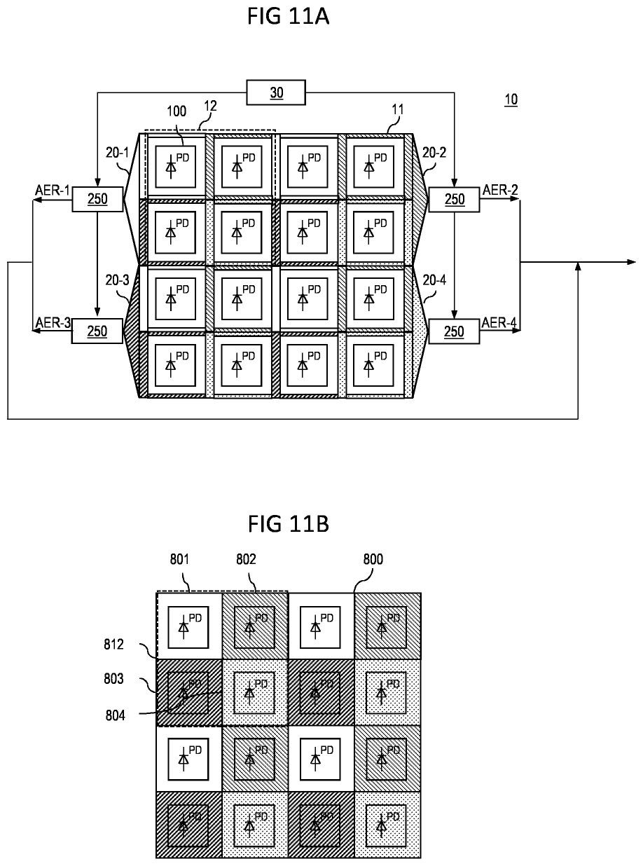

FIG. 11A shows a pixel array unit 11 with the pixel circuits 100 of the pixel groups 11-1, . . . , 11-n arranged in unit cells 12 as in FIG. 10. The pattern of the unit cells 12 may match a pattern of color filter elements 801, 802, 803, 804 of a color filter part 800 arranged at the light receiving side of the pixel circuits 100.

In particular, the image sensor may include first, second, third, and fourth color filter elements 801, 802, 803, 804 configured to filter light incident on the photoelectric conversion elements PD, wherein at least one of the second third and fourth color filter elements 802 has a different color filter type than the first color filter elements 801, and wherein each of the pixel groups 11-1, 11-n is associated with one of the color filter types.

In particular, the color filter elements 801, 802, 803, 804 may be arranged in a regular pattern of color filter unit cells 812, wherein each color filter unit cell 812 includes one first, one second, one third, and one fourth color filter element 801, 802, 803, 804, i.e. one color filter element of each color filter type. In each color filter unit cell 812, the color filter element 801, 802, 803, 804 associated with the different pixel groups 11-1, . . . , 11-n are arranged in the same way. Each color filter unit cell 812 may be associated with one unit cell 12 of pixel circuits 100.

The color filter unit cells 812 may be configured as Bayer filter, as RGBE (red-green-blue, emerald) filter, or as RGBW (red-green-blue-white) filter, by way of example. The combination of the pixel array unit 11 of FIG. 11A with the color filter part 800 of FIG. 11B enables parallel readout and separate further processing of the different color information. For example, in an embodiment concerning a microscope where multiple fluorescent dies emit at different wavelengths, the produced events can be separately processed and analyzed.

The pixel grouping according to the type of color filter is especially possible thanks to stacked processes where these connections can be easily made and can also be reconfigurable thanks to switches as explained in the following:

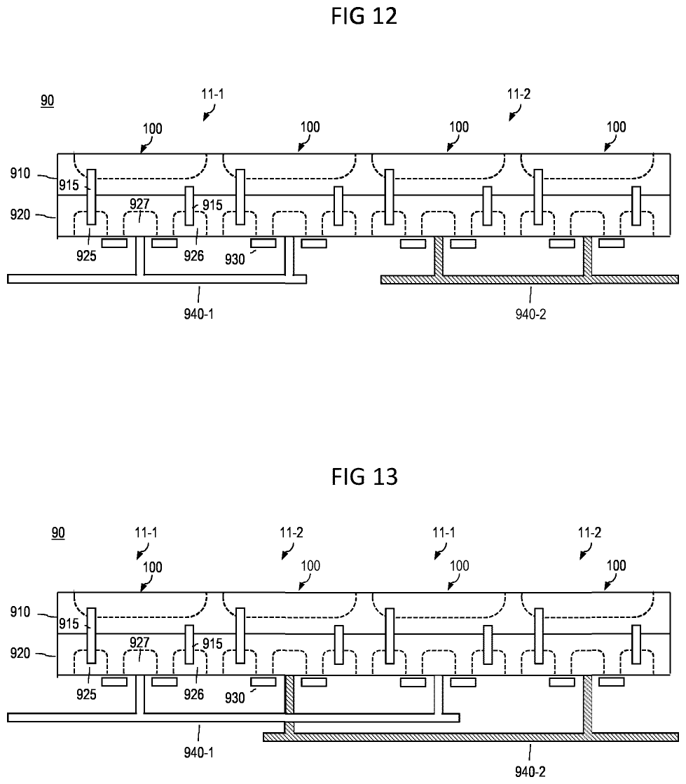

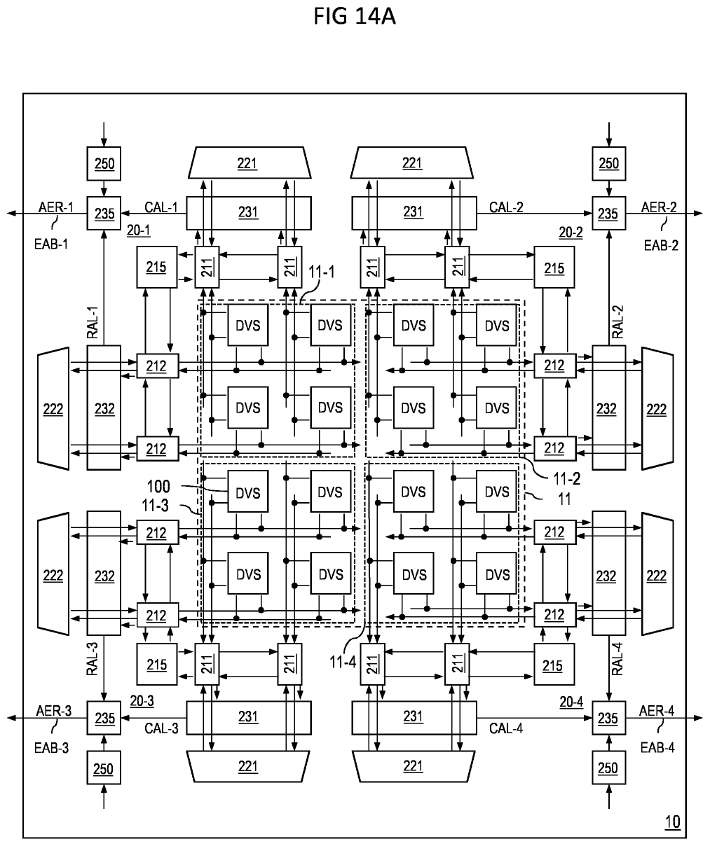

FIG. 12 and FIG. 13 show different wiring concepts for connection lines 940-1, . . . , 940-n that electrically connect the pixel circuits 100 with the readout circuits 20-1, . . . , 20-n.

The photoelectric conversion elements PD may be formed in a first chip 910. A second chip 920 is bonded to the first chip 910 on the side opposite to the light-receiving side of the first chip 910. At least some of the transistors of an event detector circuit are formed in the second chip 920, wherein the event detector circuit includes a differencing stage DS, a comparator stage CS and an in-pixel communication circuit CC as described with reference to FIG. 2A. FIG. 2B and FIG. 2C. The transistors in the second chip 920 are symbolized with doped source and drain regions 925, 926, 927 and planar gate electrodes 930. Through contact vias 915 connect elements in the first chip 910 with elements in the second chip 920.

FIG. 12 refers to an arrangement of the pixel groups 11-1, . . . , 11-n as illustrated in FIG. 9. All connection lines 940-1, . . . , 940-n electrically connecting the pixel circuits 100 and the readout circuits 20-1, . . . , 20-n may be formed in the same wiring plane and have the same distance to the semiconductor portion of the second chip 920.

FIG. 13 refers to the arrangement of the pixel circuits 100 as illustrated in FIG. 10 and FIG. 11A and shows connection lines 940-1, . . . , 940-n electrically connecting the pixel circuits 100 and the readout circuits 20-1, . . . , 20-n, wherein the connection lines 940-1, . . . , 940-n of pixel circuits 100 associated with different pixel groups 11-1, . . . , 11-n are formed in different wiring planes.

For example, for each pixel group 11-1, . . . , 11-n the connection lines 940-1, . . . , 940-n may be formed in a different wiring plane and may have a different distance to the semiconductor portion of the second chip 920 than the connection lines 940-1, . . . , 940 of the other pixel groups 11-1, . . . , 11-n.

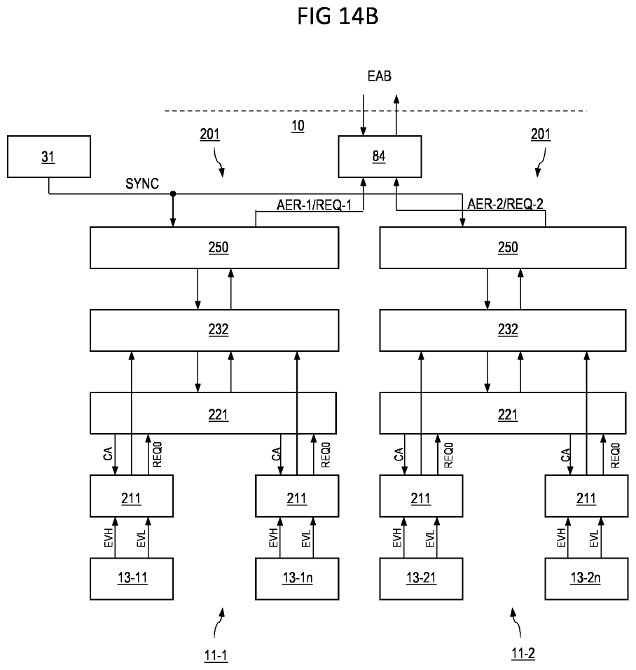

FIG. 14A shows another sensor array 10 with four pixel groups 11-1, . . . , 11-4 and four readout circuits 20-1, . . . , 20-4. Each readout circuit 20-1, 20-4 may include a column arbitration logic circuit 211 for each group pixel column, a column arbitration circuit 221, and a column address decoder 231. In case of an event in a group pixel column, the column arbitration logic circuit 211 of the concerned group pixel column may latch the event data and may request to the column arbitration circuit 221 for transmitting the group column address of the requesting group pixel column to the combiner unit 235 of the readout circuit 20-1, . . . , 20-4. The column arbitration circuit 221 arbitrates between all the column arbitration logic circuits 211 requesting to transmit an event. Once any of the requesting column arbitration logic circuits 211 has transmitted its group column address to the column address decoder 231, this column arbitration logic circuit 211 will disable its request signal. The column address decoder 231 may pass the group column address to the combiner unit 235 of the readout circuit 20-1, . . . , 20-4.

To transmit all active events in a group pixel row, first the group row address may be passed to the combiner unit 235 of the readout circuit 20-1, . . . , 20-4, e.g. through a switch. Once the group row address has been transmitted, the column address decoder 231 may be connected to the combiner unit 235 of the readout circuit 20-1, . . . , 20-4. e.g. by means of a further switch. Now all active event bits are stored in the column arbitration logic circuits 211. Those column arbitration logic circuits 211 with active events request to the column arbitration circuit 221 for access to the combiner unit 235. The column arbitration circuit 221 sequentially grants access to all requesting column arbitration logic circuits 211 by means of an acknowledge signal, until no more column arbitration logic circuit 211 is requesting and all group column addresses with events have been transmitted. Then event transmission for the next group pixel row starts.

Each readout circuit 20-1, . . . , 20-4 may further include a row arbitration logic circuit 212 for each group pixel row, a row arbitration circuit 222, and row address decoder 232 operating analogously to the column arbitration logic circuit 211, the column arbitration circuit 221, and the column address decoder 231. Each readout circuit 20-1, . . . , 20-4 may further include a column/row logic circuit 215 that controls the row-wise readout of event data.

For a synchronous readout, the readout circuits 20-1, . . . , 20-n may scan the pixel circuits 100 according to a regular pattern, e.g. row-by-row. The readout circuits 20-1, . . . , 20-n may latch the event data of the pixel circuits 100 and may generate event/address data for all pixel circuits 100 whose event data indicates an event.

FIG. 14B shows details of the column control circuits 201 for two pixel groups 11-1, 11-2.

Column arbitration logic circuits 211 receive and latch the low event signals EVL and high event signals EVH of pixel group columns 13-11, . . . , 13-1n, 13-21, . . . , 13-2n and request access to a column communication bus and column address encoder 232 from the column arbitration circuit 221 through an arbitration request signal REQ0. Once the column arbitration circuit 221 admits access to the column communication bus, the column address encoder encodes the column address of the requesting pixel group column and passes the column address to the column communication bus. The column arbitration circuit 221 further generates a column acknowledge signal CA that resets the column arbitration logic circuit 211 admitted for access to the column communication bus.

In addition, the time stamp generation unit 250 passes the time stamp to the column communication bus. The time stamp signal may be triggered at an earlier point in time, e.g., in response to the row request signal. To this purpose, a trigger signal line may connect the row control circuit of the concerned pixel group 11-1, 11-2 with the time stamp generation unit 250 associated with the concerned pixel group 11-1, 11-2 and may pass the trigger signal to the time stamp generation unit 250. A synchronization unit 31 generates a synchronization signal SYNC and passes the synchronization signal SYNC to each of the time stamp generation units 250. A row address may be added to the column communication bus.

Once group event/address data AER-1, AER-2 is completed, each column control circuit 201 may request access to a multiplexer/demultiplexer interface 84 that may handle serialized requests and acknowledges from outside the image sensor 90.

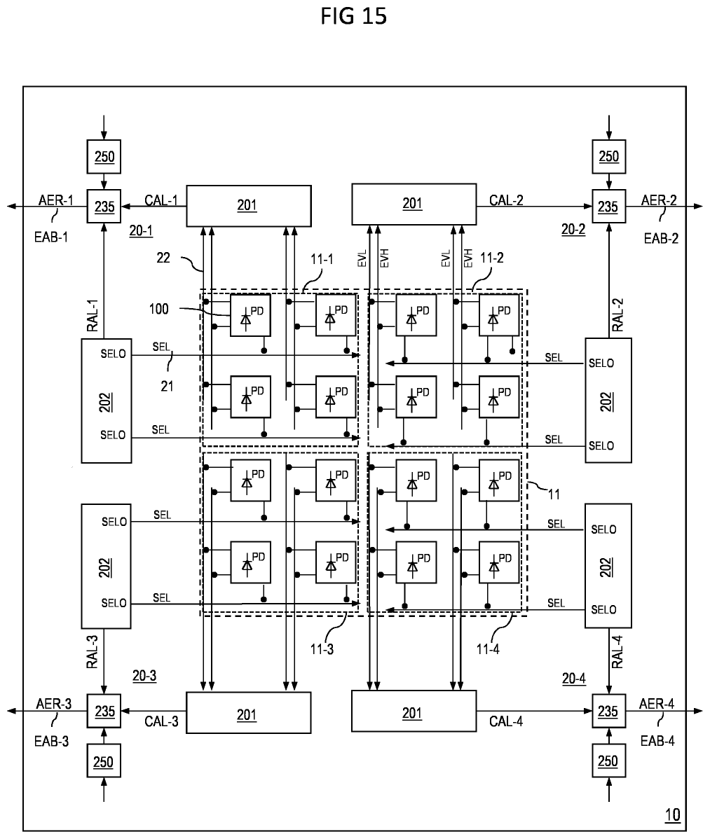

FIG. 15 shows a sensor array 10 with four pixel groups 11-1, . . . , 11-4 and four readout circuits 20-1, . . . , 20-4 for synchronous readout. The pixel circuits 100 may have a configuration as illustrated in FIG. 2C. Each readout circuit 20-1, . . . , 20-4 includes a row control circuit 202 and a column control circuit 201. Each row control circuit 202 may regularly scan the respective pixel group 11-1, . . . , 11-4 by successively selecting the group pixel rows according to a predefined rule, e.g. row-by-row. Each column control circuits 201 may latch the event data of the pixel circuits 100 and may generate group event/address data for all pixel circuits 100 whose event data indicates an event at the time the respective group pixel row has been selected.

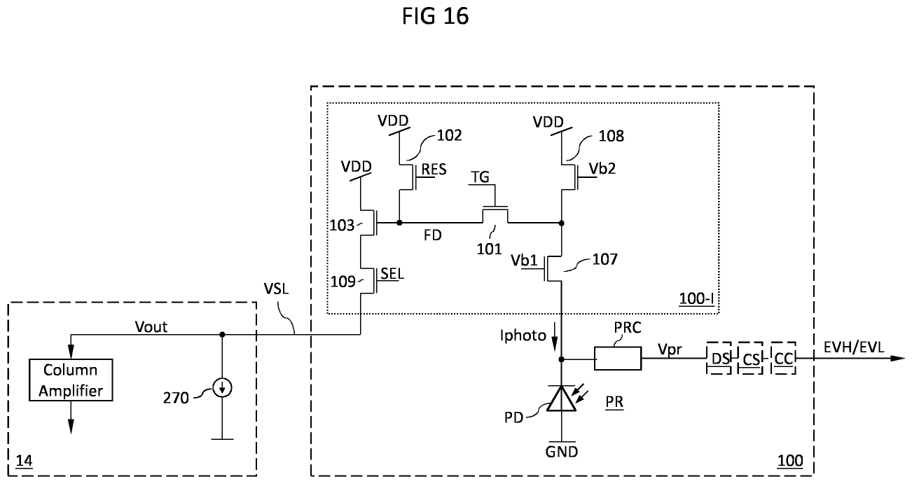

FIG. 16 refers to a pixel circuit 100 including a photoreceptor module PR for event detection and an intensity readout circuit 100-I, wherein the intensity readout circuit 100-I and the photoreceptor module PR share a common photoelectric conversion element PD. The photoreceptor module PR includes a photoreceptor circuit PRC that converts the photocurrent Iphoto into a photoreceptor signal Vpr, wherein a voltage of the photoreceptor signal Vpr is a function of the photocurrent Iphoto, and wherein in the range of interest the voltage of the photoreceptor signal Vpr increases with increasing photocurrent Iphoto. The photoreceptor circuit PRC may include a logarithmic amplifier.

The pixel circuit 100 further includes an event detector circuit that receives the photoreceptor signal Vpr and that generates a pixel event signal EVL. EVH when a change of the voltage level of the photoreceptor signal Vpr exceeds or falls below a predetermined threshold. The event detector circuit may include a differencing stage DS, a comparator stage CS and an in-pixel communication circuit CC as described with reference to FIG. 2A. FIG. 2B and FIG. 2C.

The intensity readout circuit 100-I includes an n-channel anti-blooming transistor 108 and an n-channel decoupling transistor 107 which are electrically connected in series between the high supply voltage VDD and the photoelectric conversion element PD. The anti-blooming transistor 108 and the decoupling transistor 107 may be controlled by fixed bias voltages Vb2, Vb1 applied to the gates. Additional elements, e.g. a controlled path of a feedback portion of the photoreceptor circuit PRC may be electrically connected in series between the decoupling transistor 107 and the photoelectric conversion element PD.

Decoupling transistor 107 may basically decouple the photoreceptor circuit PRC from voltage transients at the center node between the decoupling transistor 107 and the anti-blooming transistor 108. The anti-blooming transistor 108 may ensure that the voltage at the center node between the decoupling transistor 107 and the anti-blooming transistor 108 does not fall below a certain level given by the difference between the bias voltage Vb2 at the gate of the anti-blooming transistor 108 and the threshold voltage of the anti-blooming transistor 108 in order to ensure proper operation of the photoreceptor circuit PRC.

The source of the n-channel transfer transistor 101 is connected between the center node between the decoupling transistor 107 and the anti-blooming transistor 108 and a floating diffusion region FD. The transfer transistor 101 serves as transfer element for transferring charge from the photoelectric conversion element PD to the floating diffusion region FD. The floating diffusion region FD serves as temporary local charge storage. A transfer signal TG serving as a control signal is supplied to the gate (transfer gate) of the transfer transistor 101 through a transfer control line. Thus, the transfer transistor 101 may transfer electrons photoelectrically converted by the photoelectric conversion element PD to the floating diffusion region FD.

A reset transistor 102 is connected between the floating diffusion region FD and a power supply line to which a positive supply voltage VDD is supplied. A reset signal RES serving as a control signal is supplied to the gate of the reset transistor 102 through a reset control line. Thus, the reset transistor 102 serving as a reset element resets a floating diffusion potential of the floating diffusion region FD to that of the power supply line supplying the positive supply voltage VDD.

The floating diffusion region FD is connected to the gate of an amplification transistor 103 serving as an amplification element. The floating diffusion region FD functions as the input node of the amplification transistor 103.

The amplification transistor 103 and the selection transistor 109 are connected in series between the power supply line VDD and the data signal line VSL. Thus, the amplification transistor 103 is connected to the data signal line VSL through the selection transistor 109.

A selection signal SEL serving as a control signal corresponding to an address signal is supplied to the gate of the selection transistor 109 through a selection control line, and turns on the selection transistor 109. When the selection transistor 109 is turned on the amplification transistor 103 amplifies the floating diffusion potential of the floating diffusion region FD and outputs a voltage corresponding to the floating diffusion potential to the data signal line VSL. The data signal line VSL passes the pixel output signal Vout from the pixel circuit 100 to a column signal processing unit 14 for intensity readout.

Since the respective gates of the transfer transistor 101, the reset transistor 102, and the selection transistor 109 are, for example, connected in units of pixel rows, these operations may be simultaneously performed for each of the pixel circuits 100 of one pixel row.

The data signal line VSL is further connected to a constant current circuit 290 that at least temporarily supplies a constant current to the data signal line VSL.

The amplifier transistor 103 of the pixel circuit 100 and the constant current circuit 290 complement each other to a source follower circuit passing a pixel output signal Vout derived from the floating diffusion potential to the column signal processing unit 14. The column signal processing unit 14 may include analog-to-digital converters that transform the received pixel output signal Vout into digital pixel data.

Alternative embodiments of the intensity readout circuit 100-I may be realized without transfer transistor 101, wherein the reset transistor 102 may replace the anti-blooming transistor 108, and wherein the source of the reset transistor 102 may be directly connected to the gate of the amplifier transistor 103.

In the photoreceptor circuit block of FIG. 16, the intensity detection circuit 100-I and the photoreceptor circuit PRC for event detection are electrically connected in series with respect to the photocurrent Iphoto, wherein evaluation of intensity and detection of events may be performed substantially contemporaneously.

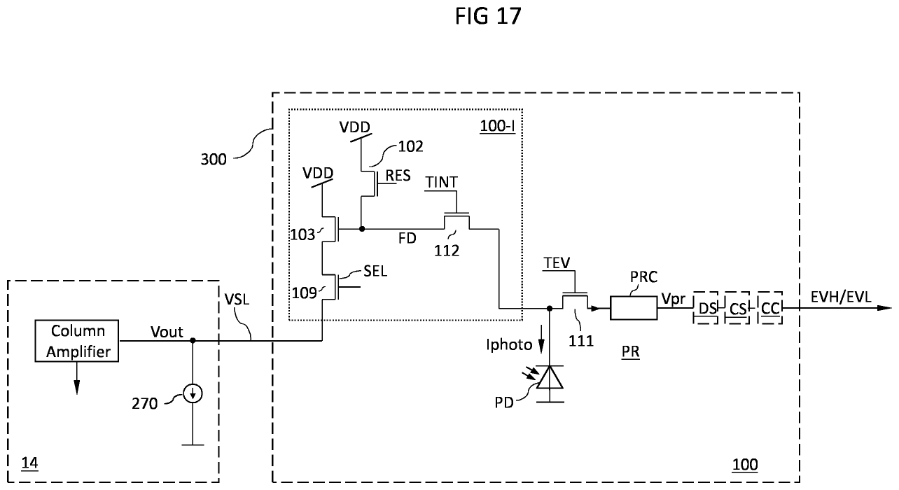

The pixel circuit 100 in FIG. 17 includes a first mode selector 111 and a second mode selector 112. The first mode selector 111 is connected between the cathode of the photoelectric conversion element PD and a photoreceptor circuit PRC. The second mode selector 112 is connected between the cathode of the photoelectric conversion element PD and the amplifier transistor 103 of an intensity readout circuit 100-I. A first mode selector signal TEV controls the first mode selector 111. A second mode selector signal TINT controls the second mode selector 112.

The first and second mode selectors 111, 112 electrically connect the photoelectric conversion element PD with the photoreceptor circuit PRC in a first operating state and with the intensity readout circuit 100-I in a second operating state. In addition, the first and second mode selectors 111, 112 may disconnect the photoelectric conversion element PD from the intensity readout circuit 100-I in the first operating state and may disconnect the photoelectric conversion element PD from the photoreceptor circuit PRC in the second operating state. The first and second mode selectors 111, 112 may be electronic switches, for example FETs or transfer gates.

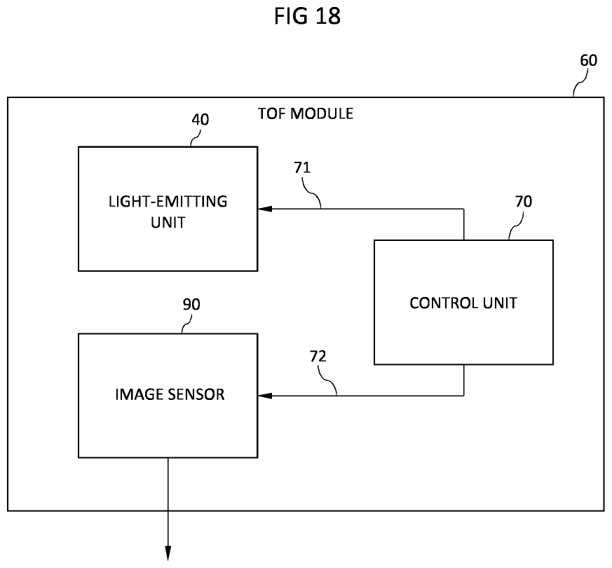

FIG. 18 is a block diagram illustrating a configuration example of a ToF (time-of-flight) module 60 according to an embodiment of the present technology. The ToF module 60 may be an electronic apparatus that measures a distance by a time of flight method, and includes a light-emitting unit 40, a control unit 70, and an image sensor 90 as described in the preceding figures.

The light-emitting unit 40 intermittently emits irradiation light to irradiate an object with the irradiation light. For example, the light-emitting unit 40 generates irradiation light in synchronization with a light-emission control signal of a rectangular wave. In addition, the light-emitting unit 40 may include a photodiode, and near infrared light and the like can be used as the irradiation light. Furthermore, the light-emission control signal is not limited to the rectangular wave as long as the light-emission control signal is a periodic signal. For example, the light-emission control signal may be a sinusoidal wave. In addition, the irradiation light may be visible light and the like without limitation to near infrared light.

The control unit 70 controls the light-emitting unit 40 and the image sensor 90. The control unit 70 generates the light-emission control signal and may supply the light-emission control signal to the light-emitting unit 40 and the image sensor 90 through signal lines 71 and 72. For example, a frequency of the light-emission control signal may be 20 megahertz (MHz). Furthermore, the frequency of the light-emission control signal may be 5 megahertz (MHZ) and the like without limitation to 20 megahertz (MHZ).

The image sensor 90 receives reflected light of the intermittent irradiation light and measures a distance from an object by the ToF method. The image sensor 90 may generate distance measurement data indicating a measured distance and may output the distance measurement data to an outer side. With the image sensor 90 including pixel circuits arranged in pixel groups as described with reference to the preceding figures and with parallel readout from the pixel groups, the ToF module combines high processing speed and high accuracy and therefore high temporal and spatial resolution.

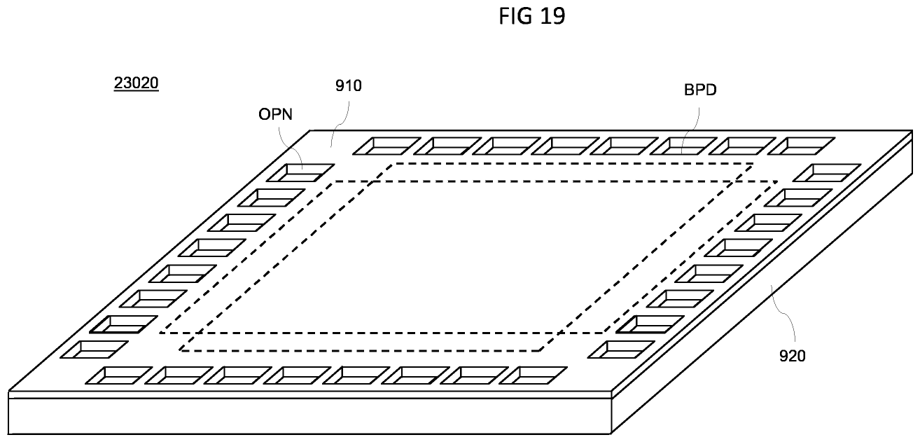

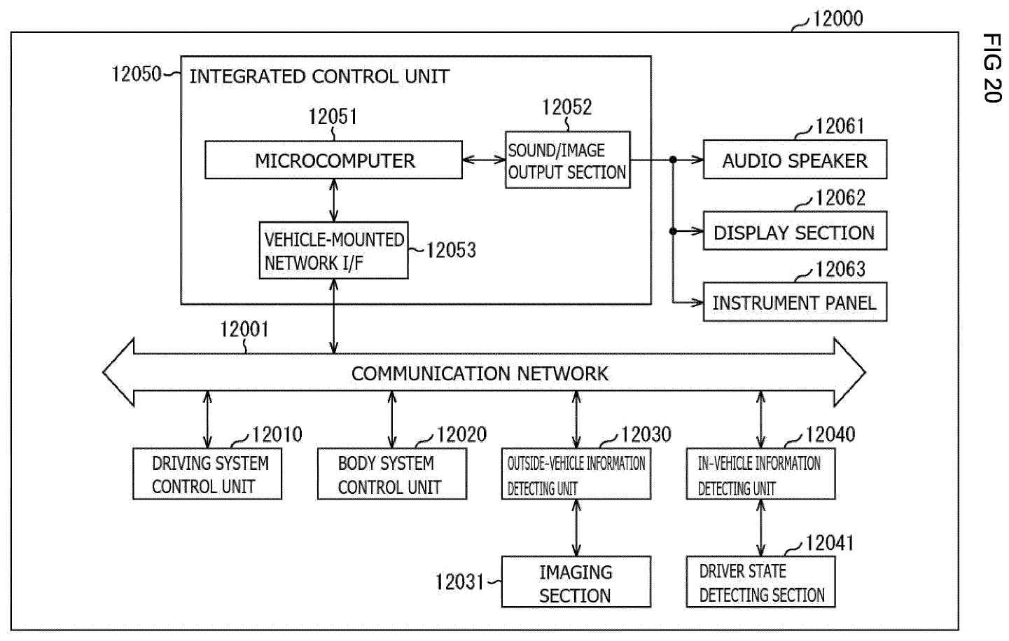

FIG. 19 is a perspective view showing an example of a laminated structure of a solid-state imaging device 23020 (image sensor) with a plurality of pixels (pixel circuits) arranged matrix-like in array form. Each pixel includes at least one photoelectric conversion element.

The solid-state imaging device 23020 has the laminated structure of a first chip (upper chip) 910 and a second chip (lower chip) 920. The laminated first and second chips 910, 920 may be electrically connected to each other through TC(S) Vs (Through Contact (Silicon) Vias) formed in the first chip 910. The solid-state imaging device 23020 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel circuit, e.g., the photoelectric conversion elements arranged in array form.

For example, the first chip 910 may include only the photoelectric conversion elements of the pixel circuits as described above with reference to the preceding of the preceding figures. Alternatively, the first chip 910 may include further elements of each pixel circuit.

Referring to FIG. 2A. FIG. 2B and FIG. 2C, the first chip 910 may include, in addition to the photoelectric conversion elements PD, at least some of the transistors of the photoreceptor module PR, for example the complete photoreceptor module PR. In the latter case, the first chip 910 may include at least the memory capacitor 121 of the differencing stage DS, for example the complete differencing stage DS. In the latter case, the first chip 910 may include the comparators of the comparator stage CS, for example the complete comparator stage CS. In the latter case, the first chip 910 may include at least part of the in-pixel communication circuit CC, for example the complete in-pixel communication circuit CC. Alternatively or in addition, the first chip may include the transfer transistor, the reset transistor, the amplifier transistor, and/or the selection transistor of pixel circuits 100 including intensity readout circuits.

The second chip 920 may be mainly a logic chip (digital chip) that includes the elements complementing the elements on the first chip 910 to complete pixel circuits 100. The second chip 920 may also include analog circuits. for example circuits that quantize analog signals transferred from the first chip 910 through the TCVs. For example, the second chip 920 may include all or at least some of the components of the readout circuits 20-1, . . . , 20-n shown in FIG. 1.

The second chip 920 may have one or more bonding pads BPD and the first chip 910 may have openings OPN for use in wire-bonding to the second chip 920. The solid-state imaging device 23020 with the laminated structure of the two chips 910, 920 may have the following characteristic configuration:

The electrical connection between the first chip 910 and the second chip 920 is performed through, for example, the TCVs. The TCVs may be arranged at chip ends or between a pad region and a circuit region. The TCVs for transmitting control signals and supplying power may be mainly concentrated at, for example, the four corners of the solid-state imaging device 23020, by which a signal wiring area of the first chip 910 can be reduced.

The technology according to the present disclosure may be realized in a light receiving device mounted in a mobile body of any type such as automobile, electric vehicle, hybrid electric vehicle, motorcycle, bicycle, personal mobility, airplane, drone, ship, or robot.

FIG. 20 is a block diagram depicting an example of a schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 20, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include an image sensor with the pixel circuits arranged in pixel groups for parallel readout according to the embodiments of the present disclosure. The light received by the imaging section 12031 may be visible light, or may be invisible light such as infrared ray's or the like.

The in-vehicle information detecting unit 12040 detects information about the inside of the vehicle and may be or may include an image sensor with the pixel circuits arranged in pixel groups for parallel readout according to the embodiments of the present disclosure. The in-vehicle information detecting unit 12040 is, for example, connected with a driver state detecting section 12041 that detects the state of a driver. The driver state detecting section 12041, for example, includes a camera that includes an image sensor according to the present embodiments and that is focused on the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 20, an audio speaker 12061, a display section 12062, and an instrument panel 12063 are illustrated as the output device. The display section 12062 may, for example, include at least one of an on-board display or a head-up display, wherein each of them may include a solid-state imaging device using a latch comparator circuit for event detection.

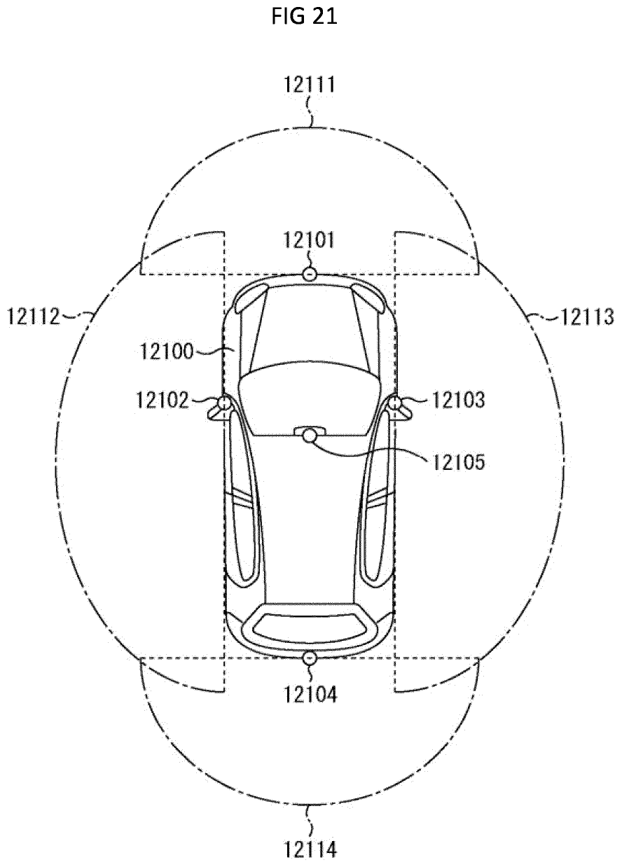

FIG. 21 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally. FIG. 21 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, imaging element having pixels for phase difference detection or may include a ToF module including an image sensor with the pixel circuits arranged in pixel groups and with parallel readout of the pixel groups according to the present disclosure.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than ( ) km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100) as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to an embodiment of the present disclosure is applicable has been described above.

Embodiments of the present technology are not limited to the above-described embodiments, but various changes can be made within the scope of the present technology without departing from the gist of the present technology.

A solid-state imaging device including the image sensor with the pixel circuits associated with different pixel groups according to the present disclosure may be any device used for analyzing and/or processing radiation such as visible light, infrared light, ultraviolet light, and X-rays. For example, the solid-state imaging device may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device including the image sensor with the pixel circuits associated with different pixel groups according to the present disclosure may be a device for capturing an image to be provided for appreciation, such as a digital camera, a smart phone, or a mobile phone device having a camera function. In the field of traffic, for example, the solid-state imaging device may be integrated in an in-vehicle sensor that captures the front, rear, peripheries, an interior of the vehicle, etc, for safe driving such as automatic stop, recognition of a state of a driver, or the like, in a monitoring camera that monitors traveling vehicles and roads, or in a distance measuring sensor that measures a distance between vehicles or the like.

In the field of home appliances, the solid-state imaging device including the image sensor with the pixel circuits associated with different pixel groups according to the present disclosure may be integrated in any type of sensor that can be used in devices provided for home appliances such as TV receivers, refrigerators, and air conditioners to capture gestures of users and perform device operations according to the gestures. Accordingly the solid-state imaging device may be integrated in home appliances such as TV receivers, refrigerators, and air conditioners and/or in devices controlling the home appliances. Furthermore, in the field of medical and healthcare, the solid-state imaging device may be integrated in any type of sensor, e.g. a solid-state image device, provided for use in medical and healthcare, such as an endoscope or a device that performs angiography by receiving infrared light.

In the field of security, the solid-state imaging device including the image sensor with the pixel circuits associated with different pixel groups according to the present disclosure can be integrated in a device provided for use in security, such as a monitoring camera for crime prevention or a camera for person authentication use. Furthermore, in the field of beauty, the solid-state imaging device can be used in a device provided for use in beauty, such as a skin measuring instrument that captures skin or a microscope that captures a probe. In the field of sports, the solid-state imaging device can be integrated in a device provided for use in sports, such as an action camera or a wearable camera for sport use or the like. Furthermore, in the field of agriculture, the solid-state imaging device can be used in a device provided for use in agriculture, such as a camera for monitoring the condition of fields and crops.

The present technology can also be configured as described below:

(1) An image sensor, including:
a pixel array unit comprising a plurality of pixel circuits, wherein each pixel circuit comprises a photoelectric conversion element, wherein each pixel circuit is configured to output a pixel event signal, and wherein each pixel circuit is associated with one of n pixel groups, with n being an integer number ≥4; and readout circuits, wherein each readout circuit is configured to receive the pixel event signals of one of the pixel groups and to output group event/address data, wherein the group event/address data contains a time stamp and identifies pixel circuits outputting an active pixel event signal.

(2) The image sensor according to (1), further including:
time stamp generation units, wherein each time stamp generation unit is configured to generate a time stamp and to pass the time stamp to one of the readout circuits.

(3) The image sensor according to (2), wherein each readout circuit is configured to generate and output group event/address data containing at least a time stamp and a row address.

(4) The image sensor according to (2), further comprising:
a synchronization unit configured to generate a synchronization signal and to pass the synchronization signal to each of the time stamp generation units.

(5) The image sensor according to any of (1) to (4), further comprising:
a memory circuit configured to receive the group event/address data from the readout circuits and to store the group event/address data.

(6) The image sensor according to any of (1) to (5), further comprising:
a serial interface circuit configured to receive the group event/address data from the readout circuits and to generate serial event/address data.

(7) The image sensor according to any of (1) to (6), further comprising:
a multiple bus interface configured to pass the group event/address data to a complementary bus interface.

(8) The image sensor according to any of (1) to (7).
wherein the pixel circuits of each pixel group are arranged side-by-side in a rectangular part of the pixel array unit.

(9) The image sensor according to any of (1) to (8),
wherein the pixel circuits of the pixel groups are interleaved with each other.

(10) The image sensor according to (9), further comprising:
first, second, third, and fourth color filter elements configured to filter light impinging on the photoelectric conversion elements, wherein at least one of the second, third, and fourth color filter elements has a different color filter type than the first color filter elements, and wherein each of the pixel groups is associated with one of the color filter types.

(11) The image sensor according to any of (9) to (10), further comprising:
connection lines electrically connecting the pixel circuits and the readout circuits, wherein the connection lines of pixel circuits associated with different pixel groups are formed in different wiring planes.

(12) The image sensor according to any of (1) to (11),
wherein the pixel event signals include a row request signal, wherein each readout circuit comprises a row control circuit, and wherein the row control circuit is configured to receive the row request signals of one pixel group and to pass row addresses of pixel group rows with active row request signals to a row address bus.

(13) The image sensor according to any of (1) to (12),
wherein the pixel event signals include a high event signal and a low event signal, wherein each readout circuit comprises a column control circuit, and wherein each column control circuit is configured to receive the high event signals and the low event signals of one pixel group and to pass column addresses of pixel group columns with active high event signal or active low event signal to a column address bus.

(14) The image sensor according to any of (1) to (13),
wherein each pixel circuit includes an intensity readout circuit.

(15) A time-of-flight module, comprising an image sensor, wherein the image sensor comprises:
a pixel array unit comprising a plurality of pixel circuits, wherein each pixel circuit comprises a photoelectric conversion element, wherein each pixel circuit is configured to output a pixel event signal, and wherein each pixel circuit is associated with one of n pixel groups, with n being an integer number ≥4; and
readout circuits, wherein each readout circuit is configured to receive the pixel event signals of one of the pixel groups and to output group event/address data, wherein the group event/address data contains a time stamp and identifies pixel circuits outputting an active pixel event signal.

1. An image sensor, comprising:
a pixel array unit comprising a plurality of pixel circuits, wherein each pixel circuit comprises a photoelectric conversion element, wherein each pixel circuit is configured to output a pixel event signal, and wherein each pixel circuit is associated with one of n pixel groups, with n being an integer number ≥4; and
readout circuits, wherein each readout circuit is configured to receive the pixel event signals of one of the pixel groups and to output group event/address data, wherein the group event/address data contains a time stamp and identifies pixel circuits outputting an active pixel event signal.

2. The image sensor according to claim 1, further comprising:
time stamp generation units, wherein each time stamp generation unit is configured to generate a time stamp and to pass the time stamp to one of the readout circuits.

3. The image sensor according to claim 2,
wherein each readout circuit is configured to generate and output group event/address data containing at least a time stamp and a row address.

4. The image sensor according to claim 2, further comprising:
a synchronization unit configured to generate a synchronization signal and to pass the synchronization signal to each of the time stamp generation units.

5. The image sensor according to claim 1, further comprising:
a memory circuit configured to receive the group event/address data from the readout circuits and to store the group event/address data.

6. The image sensor according to claim 1, further comprising:
a serial interface circuit configured to receive the group event/address data from the readout circuits and to generate serial event/address data.

7. The image sensor according to claim 1, further comprising:
a multiple bus interface configured to pass the group event/address data to a complementary bus interface.

8. The image sensor according to claim 1,
wherein the pixel circuits of each pixel group are arranged side-by-side in a rectangular part of the pixel array unit.

9. The image sensor according to claim 1,
wherein the pixel circuits of the pixel groups are interleaved with each other.

10. The image sensor according to claim 9, further comprising:
first, second, third, and fourth color filter elements configured to filter light impinging on the photoelectric conversion elements, wherein at least one of the second, third, and fourth color filter elements has a different color filter type than the first color filter elements, and wherein each of the pixel groups is associated with one of the color filter types.

11. The image sensor according to claim 9, further comprising:
connection lines electrically connecting the pixel circuits and the readout circuits, wherein the connection lines of pixel circuits associated with different pixel groups are formed in different wiring planes.

12. The image sensor according to claim 1,
wherein the pixel event signals include a row request signal, wherein each readout circuit comprises a row control circuit, and wherein the row control circuit is configured to receive the row request signals of one pixel group and to pass row addresses of pixel group rows with active row request signals to a row address bus.

13. The image sensor according to claim 1,
wherein the pixel event signals include a high event signal and a low event signal, wherein each readout circuit comprises a column control circuit, and wherein each column control circuit is configured to receive the high event signals and the low event signals of one pixel group and to pass column addresses of pixel group columns with active high event signal or active low event signal to a column address bus.

14. The image sensor according to claim 1,
wherein each pixel circuit includes an intensity readout circuit.

15. A time-of-flight module, comprising:
an image sensor, wherein the image sensor comprises.
a pixel array unit comprising a plurality of pixel circuits, wherein each pixel circuit comprises a photoelectric conversion element, wherein each pixel circuit is configured to output a pixel event signal, and wherein each pixel circuit is associated with one of n pixel groups, with n being an integer number ≥4; and
readout circuits, wherein each readout circuit is configured to receive the pixel event signals of one of the pixel groups and to output group event/address data, wherein the group event/address data contains a time stamp and identifies pixel circuits outputting an active pixel event signal.
